(19) United States
(12) Patent Application Publication
(10) Pub. No.: US 2009/0217295 A1
(43) Pub. Date: Aug. 27, 2009

(54) SYSTEM AND METHOD FOR EXTENSIBLE DOCUMENT PROCESSING

(76) Inventors: William Su, Riverside, CA (US); Hongfeng Wei, Cerritos, CA (US); Jianxin Wang, Trabuco Canyon, CA (US); Manmohan Garg, Lake Forest, CA (US); Narasimha Sastry Chivukula, Anaheim, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/037,371

(22) Filed: Feb. 26, 2008

(51) Int. Cl. G06F 9/44

(52) U.S. Cl. 719/317

(57) ABSTRACT

The subject application is directed to a system and method for extensible document processing. The startup of a plurality of document processing services on an associated document processing device is controlled via a service startup manager. Each of the document processing services is then interfaced with a control system via a device level interface. Data is communicated between the device level interface and an external data processing device via an agent layer interface. The agent layer interface is registered with the service startup manager. A startup of the document processing device is then commenced in accordance with the control of the service startup manager. A document processing control display is generated on a user interface associated with the document processing device, with the display including indicia corresponding to one of the functions of the external data processing device according to the agent layer interface.

### BACKGROUND OF THE INVENTION

The subject application is directed generally to customizable interfaces for information processing devices so as to allow them to simply, flexibly, and reliably engraft additional functionality for communication with other devices. The application is particularly suited for document processing devices such as multifunction peripherals, wherein users are able to add functionality to devices that operate in many diverse environments.

Document processing devices include copiers, printers, facsimile machines, electronic mail gateways, scanners, and the like. More recently, two or more document processing functions are combined in a single device, referred to as a multifunction peripheral or MFP. Devices are typically used in a shared environment such as in an office, wherein multiple users access a device through a data network.

As document processing devices become more sophisticated and powerful, so does the range of other devices with which such functionality becomes useful. The variety and number of other devices make it difficult to engraft data communication with document processing devices so as to allow such functions as device control or exchange of data. Such functionally typically requires complex or specialized coding for each device.

### SUMMARY OF THE INVENTION

In accordance with one embodiment of the subject application, there is provided a system and method directed to customizable interfaces for information processing devices so as to allow them to simply, flexibly, and reliably engraft additional functionality for communication with other devices.

Further, in accordance with one embodiment of the subject application, there is provided a system and method wherein users are able to add functionality to document processing devices that operate in many diverse environments.

Still further, in accordance with one embodiment of the subject application, there is provided an extensible document processing system. The system comprises a service startup manager adapted for controlling startup of a plurality of document processing services on an associated document processing device, a device level interface adapted for interfacing a control system for each of the document processing services, and an agent layer interface adapted for data communication between the device level interface and at least one external data processing device. The system further comprises registration means adapted for registering the agent layer interface with the service startup manager and means adapted for commencing a startup of the document processing device in accordance with control of the service startup manager. The system also includes display generator means adapted for generating a document processing control display on a user interface associated with the document processing device, the display including indicia corresponding to at least one function of the external data processing device in accordance with the agent layer interface.

In one embodiment of the subject application, the agent layer interface includes a service layer component in data communication with the device level interface and an application layer component in data communication with at least one external data processing device, wherein the service layer component is shared with at least one additional application layer component. In one embodiment, the startup manager includes monitoring means adapted for monitoring the operation of each application layer component. In a further embodiment, the startup manager further includes means for loading each application layer component.

In another embodiment of the subject application, the startup manager further includes means adapted for selectively unloading at least a portion of an application layer component in accordance with an output of the monitoring means.

In yet another embodiment of the subject application, the display generator means is comprised of a touch screen, wherein each indicia further defines an area adapted to generate a control signal corresponding to a function associated therewith.

Still further, in accordance with one embodiment of the subject application, there is provided a method for extensible document processing in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for extensible document processing according to one embodiment of the subject application;

FIG. 2 is a block diagram illustrating controller hardware for use in the system for extensible document processing according to one embodiment of the subject application;

FIG. 3 is a functional diagram illustrating the controller for use in the system for extensible document processing according to one embodiment of the subject application;

FIG. 4 is a flowchart illustrating a method for extensible document processing according to one embodiment of the subject application; and

FIG. 5 is a flowchart illustrating a method for extensible document processing according to one embodiment of the subject application.

### DETAILED DESCRIPTION OF THE PREFERRED EMBODIMENT

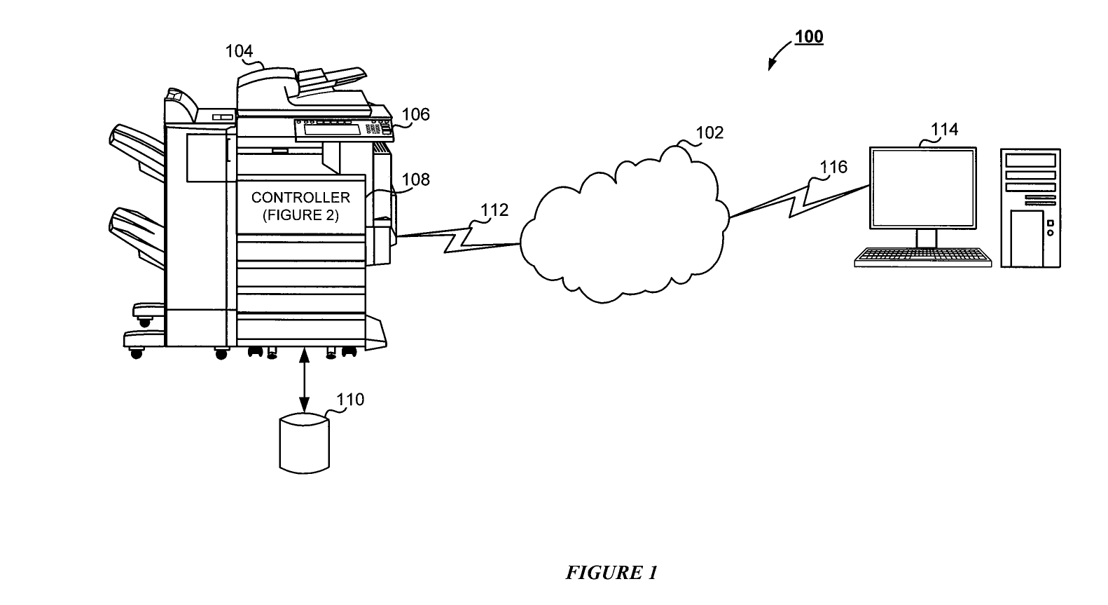

The subject application is directed to a system and method directed to customizable interfaces for information processing devices so as to allow them to simply, flexibly, and reliably engraft additional functionality for communication with other devices. In particular, the subject application is directed to a system and method wherein users are able to add functionality to document processing devices that operate in many diverse environments. More particularly, the subject application is directed to a system and method for extensible document processing. It will become apparent to those skilled in the art that the system and method described herein are suitably adapted to a plurality of varying electronic fields employing extensible processing including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for extensible document processing in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106 such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, receive input from the associated user, and communicate the same to a backend component such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

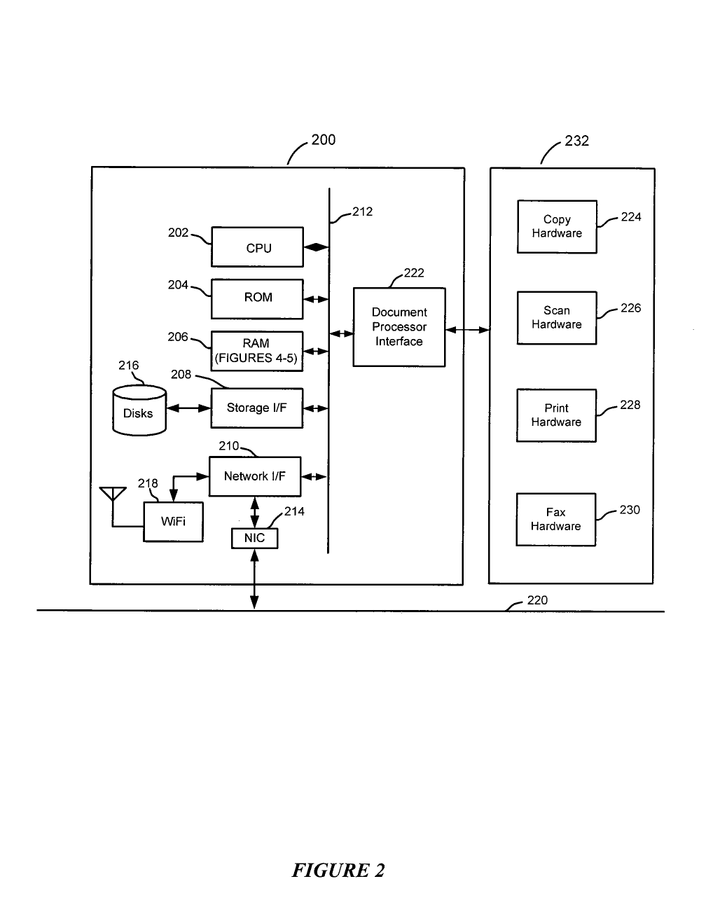

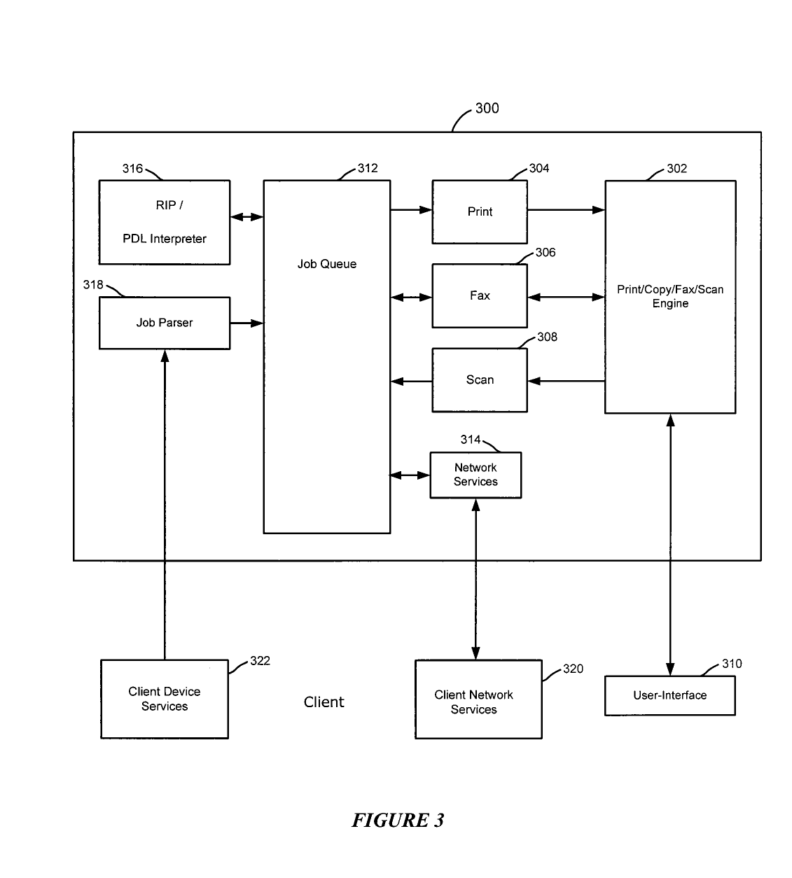

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art and, thus, the controller 108 is representative of such a general computing device and is intended as such when used hereinafter. Furthermore, the use of the controller 108 hereinafter is for the example embodiment only, and other embodiments that will be apparent to one skilled in the art are capable of employing the system and method for extensible document processing of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like.

The system 100 illustrated in FIG. 1 further depicts an external data processing device 114 in data communication with the computer network 102 via a communications link 116. It will be appreciated by those skilled in the art that the external data processing device 114 is shown in FIG. 1 as a computer workstation for illustration purposes only. As will be understood by those skilled in the art, the external data processing device 114 is representative of any suitable computing device known in the art including, for example and without limitation, a server, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to, wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the external data processing device 114 is suitably adapted to provide one or more additional functionalities, features, operations, or the like to the document processing device 104 or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202 suitably comprised of a central processor unit. However, it will be appreciated that processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206 suitably formed of dynamic random access memory, static random access memory, or any other suitable, addressable, and writable memory system. Random access memory 206 provides a storage area for data instructions associated with applications and data handling accomplished by processor 202.

A storage interface 208 suitably provides a mechanism for non-volatile, bulk, or long term storage of data associated with the controller 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, a suitable interface is provided for network-based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a parser 318, which parser 318 suitably functions to receive print job language files from an external device such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, startup of a plurality of document processing services on an associated document processing device is controlled via a service startup manager. Each of the document processing services is then interfaced with a control system via a device level interface. Data is communicated between the device level interface and at least one external data processing device via an agent layer interface. The agent layer interface is registered with the service startup manager. A startup of the document processing device is then commenced in accordance with the control of the service startup manager. A document processing control display is then generated on a user interface associated with the document processing device. The control display includes indicia corresponding to at least one function of the external data processing device in accordance with the agent layer interface.

In accordance with one example embodiment of the subject application, document processing services of the document processing device 104 are initiated via a service startup manager component resident on the controller 108. A control system, as will be understood by those skilled in the art, is then interfaced with each document processing service via a device level interface. Data is then communicated between the device level interface and an external data processing device 114, e.g., the workstation computer, via an agent layer interface. The skilled artisan will appreciate that the agent layer interface suitably represents hardware, software, or a combination thereof in data communication with the controller 108 so as to facilitate interaction between applications, devices, and the like. In accordance with one embodiment of the subject application, the agent layer interface is a software application resident on the controller 108 and suitably adapted to facilitate the incorporation and operation of a variety of software plug-ins, which add functionality, features, and the like to the associated document processing device 104. The agent layer interface is then registered with the service startup manager, as will be understood by those skilled in the art.

Application layer components of the agent layer interface are then loaded via operations of the service startup manager. Data is communicated between one of the application layer components and the external data processing device 114. The service startup manager then monitors each application layer component to determine whether the application layer component is functioning properly. When the application layer component is determined to be improperly functioning or failing to function, at least a portion of the application layer component so improperly functioning is selectively unloaded by the service startup manager. A determination is then made as to whether any additional application layer is improperly functioning. When another application layer component is not functioning properly, the service startup manager selectively unloads at least a portion of such application layer component.

Data is then communicated between a service layer component of the agent layer interface and the external data processing device 114, wherein the service layer component is shared with at least one additional application layer component. Startup of the document processing device 104 is then commenced in accordance with control by the service startup manager. A control display is then generated on the user interface 106 associated with the document processing device 104. In accordance with one embodiment of the subject application, the display includes indicia corresponding to a function of the external data processing device 114 in accordance with the agent layer interface. That is, the controller 108 or other suitable component associated with the document processing device 104 generates icons or other indicia on the user interface 106 corresponding to a function accessible through the agent layer interface that is provided by the external data processing device 114.

In accordance with one embodiment of the subject application, the user interface 106 includes a touch screen display whereupon the control signal corresponds to a user interaction with the touch screen display, such as the selection of an indicia displayed thereon corresponding to the function available from the external data processing device 114. Thereafter, a control signal is generated corresponding to an associated function of the external data processing device 114, e.g., a selection of the indicia by an associated user results in a control signal to the external device 114 to perform the function associated with the selected indicia.

The foregoing will better be understood when viewed in conjunction with an example implementation, such as the addition of a plug-in to the document processing device 104 corresponding to the uploading of a scanned image to a SharePoint picture library. It will be understood by those skilled in the art that the SharePoint client library represents a collection of routines for sending commands to and retrieving results from a SharePoint server, e.g., an external data processing device 114. The skilled artisan will appreciate that the external data processing device 114 is representative of any suitable external data processing device known in the art including, for example and without limitation, a server, a personal computer, a workstation, and the like. In accordance with this example implementation, the skilled artisan will understand that the SharePoint client library is created as a client of SharePoint Web Services, which provides all necessary web service calls to the SharePoint server, e.g., the external data processing device 114, to fulfill the scan function described above.

An application layer component, or agent, interfaces between the SharePoint client library and a generic agent, e.g., an agent resident on the controller 108 of the associated document processing device 104. A service layer component or agent is an instance of a generic agent class associated with the SharePoint service, as will be appreciated by those skilled in the art.

The service startup manager is the first service initiated on the controller 108 of the document processing device 104, as will be appreciated by those skilled in the art. The service startup manager reads the startup configuration, e.g., a configuration of services stored on the data storage device 110 communicatively coupled to the document processing device 104, and builds the configuration. The service startup manager starts all services listed in the configuration based upon the read configuration data. The service layer agent is then registered with the service startup manager. A suitable example of such a registration involves the addition of the following software code to the service startup manager extensible markup language file, or ssm.xml:

```
<Service>
  <name>SLSharePointAgent</name>
  <group />
  <exePath>./slgenagent</exePath>
  <startupType>Automatic</startupType>
  <enabled>1</enabled>
  <StartParameters>
        <Param>SLSharePointAgent</Param>
        <Param>ALSharePointAgent</Param>
        <Param>0</Param>
        <Param>0</Param>
        <Param>0</Param>
        <Param>></Param>
        <Param>ga_slsharepoint.log</Param>
  </StartParameters>
  </Service>
```

The service layer component or agent is then added, or “plugged into,” the scan workflow via the addition of the following example code to the workflow.xml file:

```
<Service name=“tiff2SharePoint”>
  <source pipeType=“fileset” dataType=“stiff”>Page%04d.tif</source>
  <agentName>SLSharePointAgent</agentName>
</Service>
```

The final step in the example implementation is to publish the agent port, which is a port identification on which a generic agent sends and receives messages. To publish the port identification, the following example SQL statement is added to the dbcreate file:

INSERT INTO agents
VALUES(‘ALSharePointAgent’,2200,5000,1,‘pdf’,‘file’,‘file’,‘file’,
NULL);
INSERT INTO agents
VALUES(‘SLSharePointAgent’,2100,4000,1,‘pdf’,‘file’,‘file’,‘file’,
NULL);

wherein, 2200 and 2100 indicate the port the agent uses to communicate, and 5000 and 4000 represent a unique number associated with the agent.

Thus, the skilled artisan will appreciate that a client library is first generated, followed by the creation of a suitable agent. The agent is then registered with the service startup manager and plugged into the workflow associated with the function. The port identification through which the agent communicates is then published, as will be understood by those skilled in the art. It will be appreciated by those skilled in the art that the preceding example is representative of one particular implementation of the system and method of the subject application and is not intended to be limiting thereto.

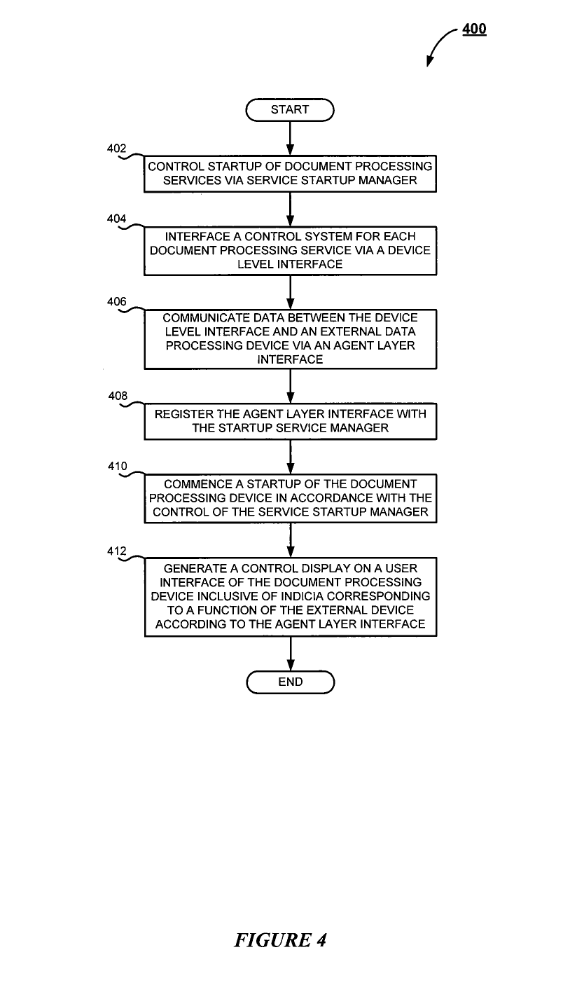

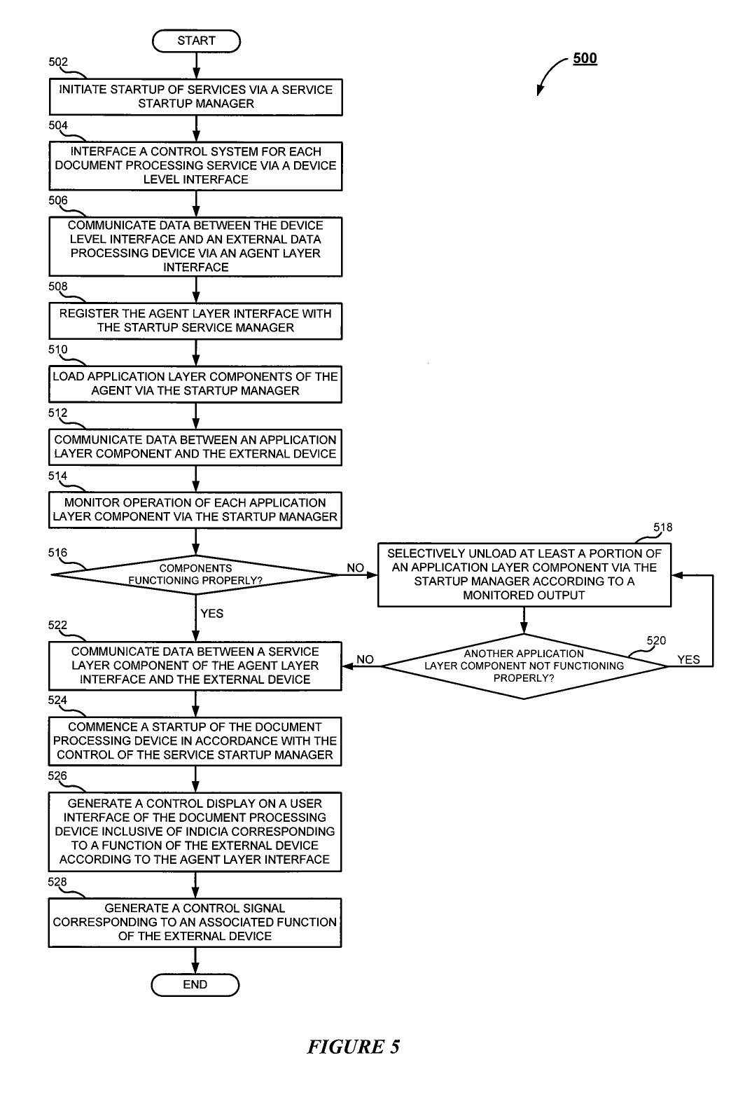

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for extensible document processing in accordance with one embodiment of the subject application. Beginning at step 402, startup of document processing services on the document processing device 104 is controlled via a service startup manager. Preferably, the service startup manager is a component, software, hardware, or a suitable combination thereof resident on the controller 108 of the document processing device 104 to facilitate the startup of document processing operations capable of being performed thereby.

At step 404, a control system is interfaced for each document processing service via a device level interface. Data is then communicated at step 406 between the device level interface and the external data processing device 114 via an agent layer interface. For example, the device level interface communicates with the external data processing device 114 via the computer network 102. At step 408, the agent layer interface is registered with the service startup manager.

At step 410, the service startup manager commences the startup of the document processing device 104. A document processing control display is then generated at step 412 on the user interface 106 associated with the document processing device 104. In accordance with one embodiment of the subject application, the control display includes indicia corresponding to at least one function of the external data processing device 114 in accordance with the agent layer interface.

Referring now to FIG. 5, there is shown a flowchart 500 illustrating a method for extensible document processing in accordance with one embodiment of the subject application. The methodology depicted in FIG. 5 begins at step 502, whereupon a service startup manager component resident on the controller 108 or other suitable component associated with the document processing device 104 initiates a plurality of document processing services associated with the document processing device 104. At step 504, a device level interface is used to interface a control system with each document processing service available via the document processing device 104. The device level interface and the external data processing device 114 then communicate data via a suitable agent layer interface at step 506. It will be appreciated by those skilled in the art that the agent layer interface represents hardware, software, or a suitable combination thereof in data communication with the controller 108 so as to facilitate interaction between applications, devices, and the like. Thus, for example and without limitation, the agent layer interface is implemented as a software application resident on the controller 108 and suitably adapted to facilitate the incorporation and operation of a variety of software plug-ins, which add functionality, features, and the like to the associated document processing device 104.

At step 508, the agent layer interface is registered with the service startup manager, as will be understood by those skilled in the art. Application layer components of the agent layer interface are then loaded at step 510 via the service startup manager. Communication of data between at least one of the application layer components and the external data processing device 114 then occurs at step 512. Monitoring of each application layer component is then undertaken by the service startup manager at step 514 for proper functioning thereof. A determination is then made at step 516 whether the components being monitored are functioning properly. For example, whether any one of the application layer components such as software plug-ins, have initiated and are functioning. When an application layer component is determined to be non-functioning or improperly functioning, flow proceeds to step 518. At step 518, at least a portion of the non-functioning or improperly functioning application layer component is unloaded by the service startup manager. That is, the service startup manager, via operation of the controller 108 or other suitable component associated with the document processing device 104, disables, e.g., “unloads” the application layer component, such as a non-functioning plug-in component.

A determination is then made at step 520 as to whether any additional application layer components being monitored by the service startup manager are non-functional, or improperly functioning. A positive determination at step 520 prompts the selective unloading of the application layer component at step 518, as set forth above. Upon a determination at step 520 that no additional application layer components are problematic or upon a determination at step 516 that all application layer components are functioning properly, flow proceeds to step 522.

At step 522, data is communicated between a service layer component of the agent layer interface and the external data processing device 114, wherein the service layer component is shared with at least one additional application layer component. Startup of the document processing device 104 is then commenced at step 524 in accordance with control by the service startup manager. At step 526, a control display is generated on the user interface 106 associated with the document processing device 104. The display generated at step 526 on the user interface 106 includes indicia corresponding to a function of the external data processing device 114 in accordance with the agent layer interface. That is, the controller 108 or other suitable component associated with the document processing device 104 generates icons or other indicia on the user interface 106 corresponding to a function accessible through the agent layer interface that is provided by the external data processing device 114. A control signal is then generated at step 528 corresponding to an associated function of the external data processing device 114, e.g., a selection of the indicia by an associated user results in a control signal to the external data processing device 114 to perform the function associated with the selected indicia. In accordance with one embodiment of the subject application, the user interface 106 includes a touch screen display whereupon the control signal corresponds to a user interaction with the touch screen display, such as the selection of an indicia displayed thereon corresponding to the function available from the external data processing device 114.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. An extensible document processing system comprising:
a service startup manager adapted for controlling startup of a plurality of document processing services on an associated document processing device;
a device level interface adapted for interfacing a control system for each of the document processing services;
an agent layer interface adapted for data communication between the device level interface and at least one external data processing device;
registration means adapted for registering the agent layer interface with the service startup manager;
means adapted for commencing a startup of the document processing device in accordance with control of the service startup manager; and
display generator means adapted for generating a document processing control display on a user interface associated with the document processing device, the display including indicia corresponding to at least one function of the external data processing device in accordance with the agent layer interface.

2. The system of claim 1 wherein the agent layer interface includes a service layer component in data communication with the device level interface and an application layer component in data communication with the at least one external data processing device, wherein the service layer component is shared with at least one additional application layer component.

3. The system of claim 2 wherein the startup manager includes monitoring means adapted for monitoring operation of each application layer component.

4. The system of claim 3 wherein the startup manager further includes means for loading each application layer component.

5. The system of claim 4 wherein the startup manager further includes means adapted for selectively unloading at least a portion of an application layer component in accordance with an output of the monitoring means.

6. The system of claim 1 wherein the display generator means is comprised of a touch screen and wherein each indicia further defines an area adapted to generate a control signal corresponding to a function associated therewith.

7. An extensible document processing method comprising the steps of:
controlling startup of a plurality of document processing services on an associated document processing device via a service startup manager;
interfacing a control system for each of the document processing services via a device level interface;
communicating data between the device level interface and at least one external data processing device via an agent layer interface;
registering the agent layer interface with the service startup manager;
commencing a startup of the document processing device in accordance with control of the service startup manager; and
generating a document processing control display on a user interface associated with the document processing device, the display including indicia corresponding to at least one function of the external data processing device in accordance with the agent layer interface.

8. The method of claim 7 further comprising the step of communicating data between a service layer component of the agent layer interface and the device level interface and communicating data between an application layer component of the agent layer interface and the at least one external data processing device, wherein the service layer component is shared with at least one additional application layer component.

9. The method of claim 8 further comprising the step of monitoring, via the startup manager, operation of each application layer component.

10. The method of claim 9 further comprising the step of loading, via the startup manager, each application layer component.

11. The method of claim 10 further comprising the step of selectively unloading, via the startup manager, at least a portion of an application layer component in accordance with an output of the monitoring step.

12. The method of claim 7 wherein the step of generating a document processing control display is via a touch screen and wherein each indicia further defines an area adapted to generate a control signal corresponding to a function associated therewith.

13. A computer-implemented method for extensible document processing comprising the steps of:
controlling startup of a plurality of document processing services on an associated document processing device via a service startup manager;
interfacing a control system for each of the document processing services via a device level interface;
communicating data between the device level interface and at least one external data processing device via an agent layer interface;
registering the agent layer interface with the service startup manager;
commencing a startup of the document processing device in accordance with control of the service startup manager; and
generating a document processing control display on a user interface associated with the document processing device, the display including indicia corresponding to at least one function of the external data processing device in accordance with the agent layer interface.

14. The computer-implemented method of claim 13 further comprising the step of communicating data between a service layer component of the agent layer interface and the device level interface and communicating data between an application layer component of the agent layer interface and the at least one external data processing device, wherein the service layer component is shared with at least one additional application layer component.

15. The computer-implemented method of claim 14 further comprising the step of monitoring, via the startup manager, operation of each application layer component.

16. The computer-implemented method of claim 15 further comprising the step of loading, via the startup manager, each application layer component.

17. The computer-implemented method of claim 16 further comprising the step of selectively unloading, via the startup manager, at least a portion of an application layer component in accordance with an output of the monitoring step.

18. The computer-implemented method of claim 13 wherein the step of generating a document processing control display is via a touch screen and wherein each indicia further defines an area adapted to generate a control signal corresponding to a function associated therewith.
